(19) United States
(12) Patent Application Publication
(10) Pub. No.: US 2015/0006689 A1
(43) Pub. Date: Jan. 1, 2015

(54) VENDOR SPECIFIC BASE STATION AUTO-CONFIGURATION FRAMEWORK

(71) Applicants: Peter Szilagyi, Budapest (HU); Henning Sanneck, Munich (DE); Raimund Kausl, Stuttgart (DE)

(72) Inventors: Peter Szilagyi, Budapest (HU); Henning Sanneck, Munich (DE); Raimund Kausl, Stuttgart (DE)

(73) Assignee: NOKIA SOLUTIONS AND NETWORKS OY, Espoo (FI)

(21) Appl. No.: 14/371,815

(22) PCT Filed: Jan. 16, 2012
(86) PCT No.: PCT/EP2012/050543

§ 371 Date: Jul. 11, 2014

(51) Int. Cl. H04L 12/24; H04W 24/02; H04L 29/12

(52) U.S. Cl. CPC H04L 41/0806; H04L 61/103; H04L 61/2076; H04W 24/02
USPC 709/222

(57) ABSTRACT

There are provided measures for a unified (i.e. multi-vendor, multi-RAT, and multi-NEM capable) network element auto-configuration framework. Such measures exemplarily comprise multi-vendor level discrimination functionality at a domain name service entity and multi-NEM/multi-RAT level discrimination functionality at a vendor-specific network element manager mediator entity having a unidirectional interface with vendor-specific network element manager entities, wherein a network element may be automatically configured with initial configuration data comprising a network address of a network element manager entity providing final configuration data for the network element.

### FIELD

The present invention relates to a unified network element auto-configuration framework. More specifically, the present invention exemplarily relates to measures (including methods, apparatuses and computer program products) for a unified (i.e. multi-vendor, multi-RAT, and multi-NEM capable) network element auto-configuration framework.

### BACKGROUND

The present specification basically relates to auto-configuration (including auto-connection and/or auto-commissioning) of network elements e.g. in a radio access network or other radio network.

In modern communication systems, there is a trend towards heterogeneity e.g. in radio access networks or other radio networks, which relates to the to the use of network elements (NEs) of different vendors within the same system, which implement different radio access technologies (RATs), and which are managed by different network element managers (NEMs). Accordingly, NEs of different vendors, different RATs and multiple NEMs of each vendor may be present within the same system being operated by a single operator. Specifically, systems referred to as heterogeneous networks (HetNet) contain network elements from different vendors implementing different radio access technologies, providing service at overlapping areas and sharing large portions of the transport network.

Such heterogeneity increases the complexity of network management including the initial configuration of network elements, as network elements from different vendors typically require different protocols and infrastructure and have different configuration sequences.

In multi-vendor heterogeneous communication system environments, network operators typically use a large number of NEs (including BTSs such as NBs, eNBs and the like) from different equipment vendors. At the same time, deployment of new NEs is required to be of plug-and-play nature (i.e., requiring no pre-configuration in the factory prior to field installation and no or as few as possible local on-site configuration during field installation). However, currently different vendors employ different auto-connection and/or auto-commissioning sequences and require different protocols and supporting nodes (e.g. DHCP servers) and access network layout (VLAN/IP domain) for their proprietary solutions to work. This causes complexity at the operator side because the different plug-and-play characteristics of the different vendors need to be integrated into a common framework.

Accordingly, in order to provide easier and faster network roll-out and base station deployment (base stations representing an example of network elements subject to auto-configuration), especially in new RATs such as Long Term Evolution (LTE), automation of initial configuration (referred to as auto-configuration) would be useful. In particular, such usefulness of simple and unified auto-configuration (including auto-connection and/or auto-commissioning) of network elements e.g. in a radio access network or other radio network becomes more and more important with the evolution of 3G (Third Generation) and LTE towards a HetNet communication system infrastructure.

In view of the above-outlined heterogeneity in modern communication systems, a desired auto-configuration (including auto-connection and/or auto-commissioning) of network elements e.g. in a radio access network or other radio network shall be based on a unified network element auto-configuration framework. Such unified network element auto-configuration framework shall preferably be multi-vendor, multi-RAT, and multi-NEM capable.

Therefore, there is a need to provide for a unified (i.e. multi-vendor, multi-RAT, and multi-NEM capable) network element auto-configuration framework.

### SUMMARY

Various exemplary embodiments of the present invention aim at addressing at least part of the above issues and/or problems and drawbacks.

Various aspects of exemplary embodiments of the present invention are set out in the appended claims.

According to an exemplary aspect of the present invention, there is provided a method comprising requesting resolution of a vendor-specific domain name at a domain name service entity, acquiring a network address of a vendor-specific network element manager mediator entity from the domain name service entity, requesting initial configuration data using the acquired network address of the vendor-specific network element manager mediator entity, and obtaining the initial configuration data, comprising a network address of a network element manager entity providing final configuration data, from the vendor-specific network element manager mediator entity.

According to an exemplary aspect of the present invention, there is provided a method comprising, upon request from a network element of a specific vendor, which is operable in a radio access network of a specific operator using a specific radio access technology, resolving a vendor-specific domain name using a mapping between vendor-specific domain names and vendor-specific network element manager mediator entities of multiple vendors, and providing a network address of a vendor-specific network element manager mediator entity of the vendor of the network element to the network element.

According to an exemplary aspect of the present invention, there is provided a method comprising, upon request from a network element of a specific vendor, which is operable in a radio access network of a specific operator using a specific radio access technology, identifying initial configuration data for the network element using a mapping between network elements and initial configuration data of multiple network element manager entities of the specific vendor, and providing the identified initial configuration data, comprising a network address of the network element manager entity providing final configuration data for the network element, to the network element.

According to an exemplary aspect of the present invention, there is provided an apparatus comprising an interface configured to communicate with at least another apparatus, and a processor configured to cause the apparatus to perform requesting resolution of a vendor-specific domain name at a domain name service entity, acquiring a network address of a vendor-specific network element manager mediator entity from the domain name service entity, requesting initial configuration data using the acquired network address of the vendor-specific network element manager mediator entity, and obtaining the initial configuration data, comprising a network address of a network element manager entity providing final configuration data, from the vendor-specific network element manager mediator entity.

According to an exemplary aspect of the present invention, there is provided an apparatus comprising an interface configured to communicate with at least another apparatus, and a processor configured to cause the apparatus to perform, upon request from a network element of a specific vendor, which is operable in a radio access network of a specific operator using a specific radio access technology, resolving a vendor-specific domain name using a mapping between vendor-specific domain names and vendor-specific network element manager mediator entities of multiple vendors, and providing a network address of a vendor-specific network element manager mediator entity of the vendor of the network element to the network element.

According to an exemplary aspect of the present invention, there is provided an apparatus comprising an interface configured to communicate with at least another apparatus, and a processor configured to cause the apparatus to perform, upon request from a network element of a specific vendor, which is operable in a radio access network of a specific operator using a specific radio access technology, identifying initial configuration data for the network element using a mapping between network elements and initial configuration data of multiple network element manager entities of the specific vendor, and providing the identified initial configuration data, comprising a network address of the network element manager entity providing final configuration data for the network element, to the network element.

According to an exemplary aspect of the present invention, there is provided a computer program product comprising computer-executable computer program code which, when the program is run on a computer (e.g. a computer of an apparatus according to any one of the aforementioned apparatus-related exemplary aspects of the present invention), is configured to cause the computer to carry out the method according to any one of the aforementioned method-related exemplary aspects of the present invention.

Such computer program product may comprise or be embodied as a (tangible) computer-readable (storage) medium or the like on which the computer-executable computer program code is stored, and/or the program may be directly loadable into an internal memory of the computer or a processor thereof.

Advantageous further developments or modifications of the aforementioned exemplary aspects of the present invention are set out in the following.

By way of exemplary embodiments of the present invention, there is provided a unified (i.e. multi-vendor, multi-RAT, and multi-NEM capable) network element auto-configuration framework. More specifically, by way of exemplary embodiments of the present invention, there are provided measures and mechanisms for a unified (i.e. multi-vendor, multi-RAT, and multi-NEM capable) network element auto-configuration framework (in/for radio access networks or other radio networks).

Thus, improvement is achieved by methods, apparatuses and computer program products enabling/realizing a unified (i.e. multi-vendor, multi-RAT, and multi-NEM capable) network element auto-configuration framework (in/for radio access networks or other radio networks).

### BRIEF DESCRIPTION OF THE DRAWINGS

In the following, the present invention will be described in greater detail by way of non-limiting examples with reference to the accompanying drawings, in which

FIG. 1 shows a schematic diagram of a first comparative example of a conventional network element auto-configuration framework,

FIG. 2 shows a schematic diagram of a second comparative example of a conventional network element auto-configuration framework,

FIG. 3 shows a schematic diagram of an exemplary procedure between apparatuses of a network element auto-configuration framework according to exemplary embodiments of the present invention,

FIG. 4 shows a schematic diagram of a first example of a network element auto-configuration framework according to exemplary embodiments of the present invention, wherein security-related aspects are exemplarily illustrated,

FIG. 5 shows a schematic diagram of a second example of a network element auto-configuration framework according to exemplary embodiments of the present invention, wherein a single-vendor case is exemplarily illustrated,

FIG. 6 shows a schematic diagram of a third example of a network element auto-configuration framework according to exemplary embodiments of the present invention, wherein a multi-vendor case is exemplarily illustrated, and

FIG. 7 shows a schematic diagram of exemplary apparatuses of a network element auto-configuration framework according to exemplary embodiments of the present invention.

### DETAILED DESCRIPTION OF DRAWINGS AND EMBODIMENTS OF THE PRESENT INVENTION

The present invention is described herein with reference to particular non-limiting examples and to what are presently considered to be conceivable embodiments of the present invention. A person skilled in the art will appreciate that the invention is by no means limited to these examples, and may be more broadly applied.

It is to be noted that the following description of the present invention and its embodiments mainly refers to specifications being used as non-limiting examples for certain exemplary network configurations and deployments. Namely, the present invention and its embodiments are mainly described in relation to 3GPP specifications being used as non-limiting examples for certain exemplary network configurations and deployments. In particular, a LTE/LTE-Advanced communication system is used as a non-limiting example for the applicability of thus described exemplary embodiments. As such, the description of exemplary embodiments given herein specifically refers to terminology which is directly related thereto. Such terminology is only used in the context of the presented non-limiting examples, and does naturally not limit the invention in any way. Rather, any other network configuration or system deployment, etc. may also be utilized as long as compliant with the features described herein.

In particular, the present invention and its embodiments may be applicable in any communication system or technology utilizing auto-configuration (including auto-connection and/or auto-commissioning) of network elements e.g. in a radio access network or other radio network.

Hereinafter, various embodiments and implementations of the present invention and its aspects or embodiments are described using several variants and/or alternatives. It is generally noted that, according to certain needs and constraints, all of the described variants and/or alternatives may be provided alone or in any conceivable combination (also including combinations of individual features of the various variants and/or alternatives).

According to exemplary embodiments of the present invention, in general terms, there are provided measures and mechanisms for (enabling/realizing) a unified (i.e. multi-vendor, multi-RAT, and multi-NEM capable) network element auto-configuration framework.

First of all, in order to facilitate explanation of the present invention and its aspects or embodiments, reference is made to conventional solutions in terms of network element auto-configuration.

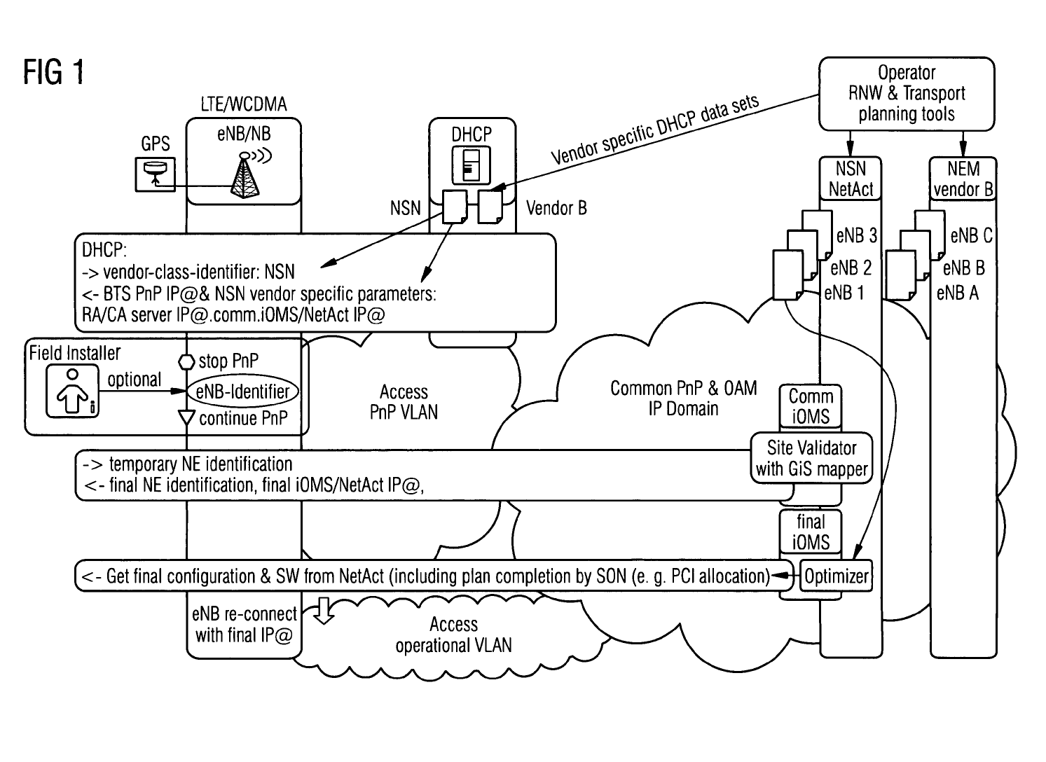

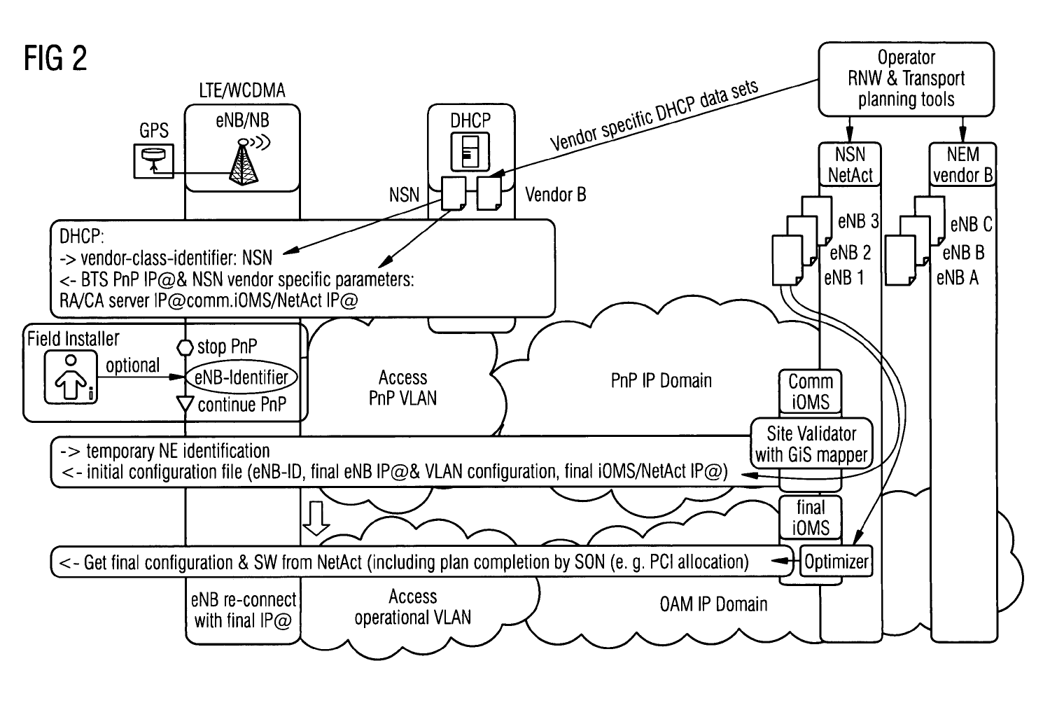

It is to be noted that FIGS. 1 and 2 are exemplarily directed to a system framework being implemented by vendor-specific entities and brand names of the applicant/assignee. In this regard, “NetAct” represents a non-limiting (vendor-specific) example for a network element manager (NEM) or network management system, and “iOMS” represents a non-limiting (vendor-specific) example for an auto-configuration server/entity. Notwithstanding such vendor-specific examples for certain entities, the thus illustrated system frameworks are generally applicable in any vendor-independent environment.

FIG. 1 shows a schematic diagram of a first comparative example of a conventional network element auto-configuration framework. In FIG. 1, there is exemplarily illustrated a system infrastructure, wherein security-related aspects are omitted for the sake of clarity.

The exemplary system infrastructure according to FIG. 1 comprises a LTE/WCDMA base station NB/eNB of a first vendor, which is to be auto-configured, a DHCP server, and two network element managers (NEMs) of different vendors (namely, NSN representing a first vendor and vendor B representing a second vendor). In the DHCP server, configuration data sets for each vendor are provided, and each one of the NEMs of the two vendors comprises configuration data for a set of NEs of that vendor (namely, eNB 1, eNB 2 and eNB 3 of NSN, and eNB A, eNB B and eNB C of vendor B).

The conventional auto-connection and auto-commissioning framework according to FIG. 1, i.e. the conventional multi-vendor plug-and-play functionality, may be summarized as follows.

Basically, the underlying communication system according to FIG. 1 is structured into separated PnP and operational access VLANs and a common PnP and OAM IP domain.

In the actual PnP auto-configuration sequence, the eNB may firstly (optionally) run a VLAN probing sequence for identifying the dedicated PnP access VLAN to be used for PnP auto-configuration. Then, the eNB may run a DHCP sequence in cooperation with the DHCP server (thus accessing the configuration data set of the vendor of the eNB, i.e. NSN), thereby getting a temporary NE identification (denoted as BTS PnP IP@) to be used for PnP auto-configuration and vendor-specific parameters, such as e.g. IP addresses of RA/CA servers (i.e. registration/authentication-related instances) and vendor-specific NEM and/or auto-configuration server/entity such as NetAct/commissioning iOMS (i.e. instances of the vendor-specific NEM).

Based thereon, the eNB may connect to the operator network, i.e. the PNP access VLAN, using its temporary identification. Thereupon, although not illustrated, the eNB may connect to the CA server to obtain PKI information as authentication information to be used for connecting to the NEM, e.g. the NetAct.

In case no GPS or another positioning service is available at the eNB for enabling a hardware-to-site mapping, the PnP auto-configuration sequence may stop after auto-connection (and security credential provisioning from RA/CA), a field installer may inject an eNB identifier which is unambiguously linked to a site location, and the PnP auto-configuration sequence may continue accordingly. In case GPS or another positioning service is available at the eNB, a fully automated hardware-to-site mapping may be performed using the geo-location information at this step, i.e. the PnP auto-configuration sequence does not have to be interrupted.

Further, the eNB may send its temporary identifier (e.g. geo-location, or site-identifier, etc) to the NEM, e.g. the NetAct, i.e. auto-configuration server/entity, e.g. the commissioning iOMS. Thereupon, the NEM, e.g. the NetAct may validate the final NE identifier corresponding to its temporary identifier, and may assign a final auto-configuration server/entity, e.g. a final iOMS, to the eNB, and the eNB may connect to the final auto-configuration server/entity, e.g. the final iOMS, and download (final) configuration data and software as well as final IP address of auto-configuration server/entity and/or NEM e.g. the iOMS/NetAct, from the NEM, e.g. the NetAct, i.e. the final auto-configuration server/entity, e.g. the final iOMS.

Based thereon, the eNB may re-connect to the operator network, i.e. the operational access VLAN, using its final identification, i.e. with the final IP address for the management-related connectivity (“m-plane”) IP@. Thereupon, the network integration may continue accordingly.

For further details, reference is made to the illustrations and inscriptions in FIG. 1.

A basic problem of the conventional network element auto-configuration framework according to FIG. 1 is the use of a common PnP and OAM IP domain. Stated in other words, a separation between a PnP and an OAM IP domains (on OSI layer 3) is not supported, but only a separation between the PnP and operational access VLAN domains (on OSI layer 2). The common PnP and OAM IP domain e.g. poses a threat from security point of view.

FIG. 2 shows a schematic diagram of a second comparative example of a conventional network element auto-configuration framework. In FIG. 2, there is exemplarily illustrated a system infrastructure, wherein security-related aspects are omitted for the sake of clarity.

The exemplary system infrastructure according to FIG. 2 is similar to that according to FIG. 1, and thus reference is made to the above description for details.

However, the structure of the underlying communication system differs from that according to FIG. 1 in that a true domain separation is provided. That is to say, the underlying communication system according to FIG. 2 is structured into separated PnP and operational access VLANs and separated PnP and OAM IP domains.

The conventional auto-connection and auto-commissioning framework according to FIG. 2, i.e. the conventional multi-vendor plug-and-play functionality, is basically similar to that according to FIG. 1. For details, reference is made to the illustrations and inscriptions in FIG. 2 in connection with the above description relating to FIG. 1.

The difference with respect to the conventional auto-connection and auto-commissioning framework according to FIG. 1, basically resides in that the eNB firstly gets initial configuration data from the commissioning auto-configuration server/entity, e.g. the commissioning iOMS, and thereafter—specifically, after re-connection to the operator network, i.e. the operational access VLAN, using its final identification, i.e. with the final m-plane IP@—gets final configuration data from the final auto-configuration server/entity, e.g. the final iOMS. In contrast to the final configuration data, the initial configuration data represents a pre-configured configuration file without SON completion capability (i.e. a combination of pre-configured data and data generated by execution of SON functions).

Accordingly, initial configuration data is provided from the PnP IP domain (to which the commissioning auto-configuration server/entity, e.g. iOMS, belongs) via the PnP access VLAN domain, while final configuration data is provided from the OAM IP domain (to which the final auto-configuration server/entity, e.g. iOMS, belongs) via the operational access VLAN domain.

While the conventional network element auto-configuration framework according to FIG. 2 provides for true domain separation, there remain certain problems inherent to both conventional network element auto-configuration frameworks discussed above.

Namely, a particular problem resides in the usage of the DHCP protocol, especially in acquiring IP addresses of a responsible NEM and a responsible CA server.

While DHCP is a part of basically all of conventionally known vendor-specific plug-and-play solutions, the following issues arise due to the use of DHCP in this regard (which are particularly relevant when realizing a standardized solution is desired). On the one hand, a DHCP server needs to be available in every subnet, or every subnet needs to have a node which provides DHCP relay functionality (so that a DHCP server located in another subnet can be reached). Hence some rather extensive pre-configuration of the underlying radio (access) network is required, thus adversely affecting a true PnP characteristic due to the need of pre-configurations. On the other hand, in order to support multiple vendors (i.e. to provide an indirection to different vendor-specific NEMs), DHCP options have to be used, i.e. the vendor-class-identifier (DHCP option code 60) and vendor-specific-information (DHCP option code 43) are to be employed for requesting and retrieving vendor-specific information (as evident from FIGS. 1 and 2). However, DHCP options are not well and/or consistently supported by existing (open source and commercial) DHCP implementations as standalone servers or integrated in network elements like routers. Also, even if such options were implemented, the provided capabilities may not be sufficient to realize a unified network element auto-configuration framework as required. This is because e.g. option attributes with a length of more than 255 characters are not supported.

In view thereof, it is difficult, if not impossible, to realize a unified network element auto-configuration framework with multi-vendor, multi-RAT, and multi-NEM capability.

Moreover, the security setup of both conventional network element auto-configuration frameworks discussed above also lacks required multi-vendor capability. Conventionally, the security setup is done by the eNB through accessing the Certificate Authority (CA) server of the operator. To this end, the eNB needs four pieces of information, which are signaled to the eNB by way of the DHCP protocol via the following attributes:

| DHCP attribute | Description | Length | Status |
|---|---|---|---|
| CA/CMP IP | IP address of the CA | variable | implemented |
| address | server | (4 octets) | |
| CA/CMP port | Port number of CA | variable | implemented |
| number | server | (2 octets) | |
| CMP Subject | Subject name for CA | variable string | implemented |
| Name | server (used to | (max. 100 | (but not |
| | differentiate between | octets) | always used) |
| | logical CA server entities | | |
| | in case the security | | |
| | server hosts multiple | | |
| | virtual CAs) | | |
| Path for CMP | CMP service path for | variable string | not yet |
| protocol | HTTP access | | implemented |

The first three attributes are typically implemented, but the fourth attribute (i.e. the path attribute) is currently assumed to be fixed (“pkix”) which is not true for all operators. Thus, it is an additional parameter that would need to be signaled via DHCP, if conventional frameworks were to be extended. There is a well-known TCP port number 829 called “pkix-3-ca-ra” that is usually used as the port number; however, there is no standard that mandates the CA to listen on that particular port, making it necessary to obtain this parameter from a DHCP option in conventional implementations. The CMP service is then to be accessed by the eNB at the following URL (the Subject Name is used internally within the CMP message exchange):
http://<CA-IP@>:<CA-PORT>/<path>

However, such approach is not really applicable in practice. The problem with this approach is that it relies extensively on optional DHCP attributes as described above. But even when it would be feasible to solve the basic multi-vendor issue using DHCP, providing further differentiation for multiple RATs and again further to different NEM instances would not be feasible anyway with the approach described above. This is the case because then all the information of the different vendor domains (different RATs & NEM instances) would need to be exposed to the DHCP server. Furthermore, the large amount of data would make the suitability of DHCP options even less practicable.

In view of the above, the present invention and its aspects or embodiments provides for a unified (i.e. multi-vendor, multi-RAT, and multi-NEM capable) network element auto-configuration framework, which is capable of overcoming the aforementioned problems and drawbacks as well as satisfying prevailing requirements.

In the following, the present invention and its aspects or embodiments are explained in detail.

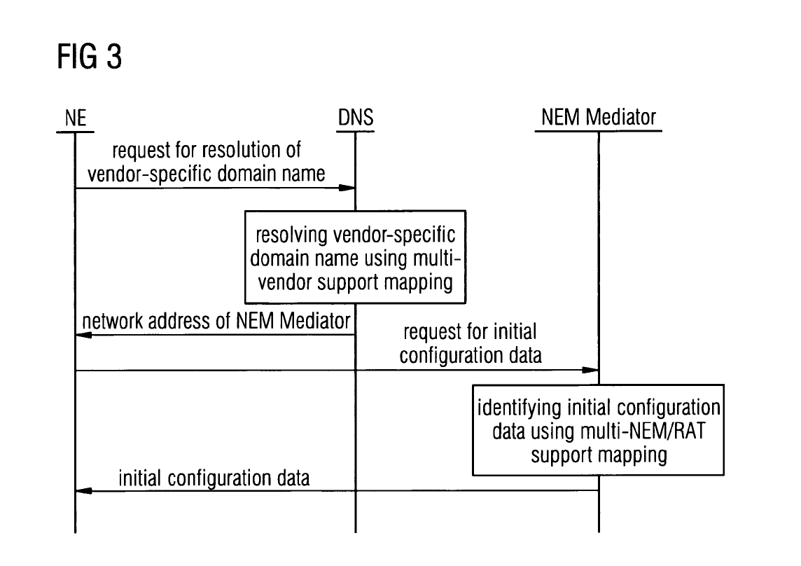

FIG. 3 shows a schematic diagram of an exemplary procedure between apparatuses of a network element auto-configuration framework according to exemplary embodiments of the present invention.

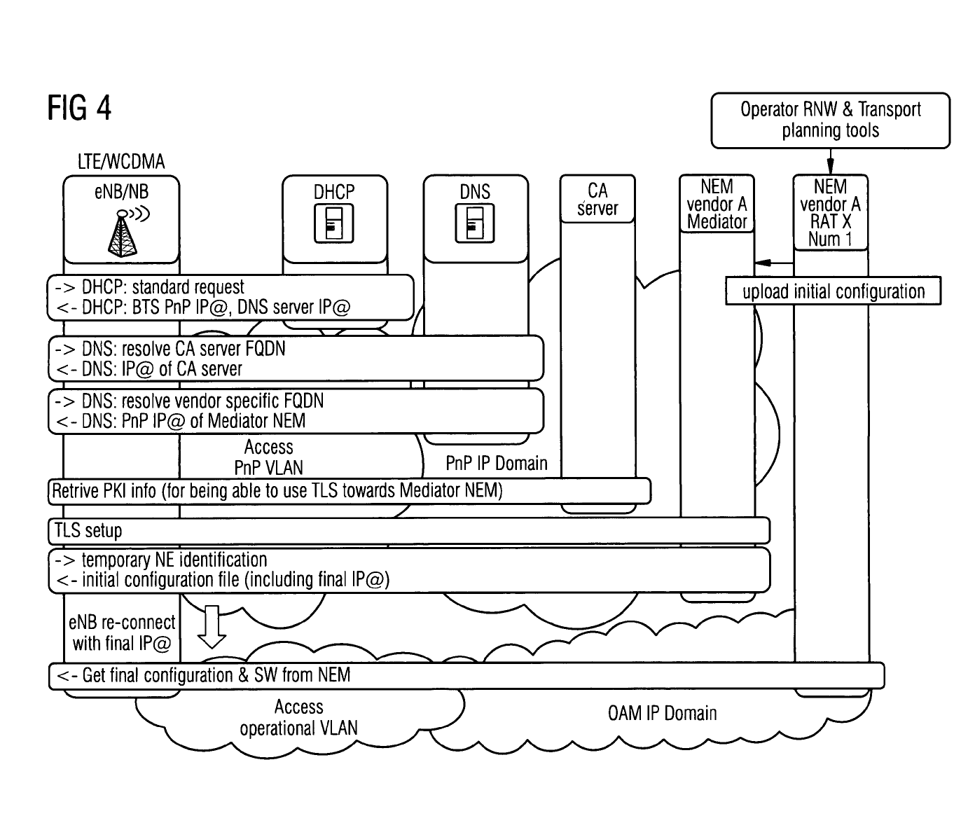

The exemplary system infrastructure according to FIG. 3 comprises a network element NE, which may exemplarily be represented by a eNB/NB according to any one of FIGS. 4 to 6, a domain name service entity DNS, which may exemplarily be represented by a DNS server according to any one of FIGS. 4 to 6, and a vendor-specific network element manager mediator entity “NEM Mediator”, which may exemplarily be represented by a NEM vendor A/B Mediator according to any one of FIGS. 4 to 6.

According to exemplary embodiments of the present invention, the NE represents a network element of a specific vendor, which is operable in a radio access network of a specific operator using a specific radio access technology.

As shown in FIG. 3, a corresponding procedure according to exemplary embodiments of the present invention comprises the following operations/functions.

The NE to be auto-configured requests resolution of a vendor-specific domain name at the DNS, the DNS—upon the request from the NE —resolves the vendor-specific domain name using a mapping between vendor-specific domain names and vendor-specific network element manager mediator entities of multiple vendors (i.e. a multi-vendor support mapping), and provides the network address of the NEM Mediator of the vendor of the NE (i.e. the NEM Mediator responsible/relevant for the NE) to the NE. Thereby, the NE acquires the network address of the NEM Mediator from the DNS, and requests initial configuration data from the NEM Mediator using the acquired network address thereof. The NEM Mediator—upon request from the NE—identifies initial configuration data for the NE using a mapping between network elements and initial configuration data of multiple network element manager entities (NEMs) of the specific vendor (i.e. a multi-NEM/RAT support mapping), and provides the identified initial configuration data, comprising a network address of the network element manager entity (NEM) providing final configuration data for the NE, to the NE. Thereby, the NE obtains the initial configuration data, comprising the network address of the network element manager entity (NEM) providing final configuration data, from the NEM Mediator.

In view thereof, a unified (i.e. multi-vendor, multi-RAT, and multi-NEM capable) network element auto-configuration framework according to exemplary embodiments of the present invention is featured in that DNS (instead of DHCP) is used in order to provide for multi-vendor support (i.e. multi-vendor level discrimination functionality) and a NEM Mediator is introduced in order to provide for multi-NEM/RAT support (i.e. multi-NEM/multi-RAT level discrimination functionality). Thereby, indirection to different vendor-specific NEMs (for different RATs) of its specific vendor may be realized for a NE to be auto-configured.

FIG. 4 shows a schematic diagram of a first example of a network element auto-configuration framework according to exemplary embodiments of the present invention, wherein security-related aspects are exemplarily illustrated (for the sake of completeness).

Similar to FIGS. 1 and 2 above, the exemplary system infrastructure according to FIG. 3 comprises a LTE/WCDMA base station NB/eNB of a specific vendor, which is to be auto-configured, a DHCP server, and a network element manager (NEM) of the specific vendor. Additionally, the exemplary system infrastructure according to FIG. 3 comprises a DNS server and a NEM mediator as well as, for security aspects, a CA server.

Similar to FIG. 2 above, the underlying communication system according to FIG. 3 is structured into separated PnP and operational access VLANs and separated PnP and OAM IP domains, thereby realizing a true domain separation. Specifically, the DNS server, the (operator-specific) CA server and the (vendor-specific) NEM Mediator are located in the PnP IP domain and are accessible via the PnP access VLAN domain (particularly, using an initial/temporary NE identification), and the (vendor-specific) NEMs are located in the OAM IP domain and are accessible via the operational access VLAN domain (particularly, using a final NE identification).

According to exemplary embodiments of the present invention, the operability/functionality of the individual entities in the context of auto-connection and auto-commissioning, i.e. multi-vendor plug-and-play, may be summarized as follows.

The DHCP server may provide an initial network address of the NE (denoted as BTS IP@) and a network address of the DNS server (denoted as DNS server IP@). Accordingly, the usage of the DHCP server is reduced to a level that must mandatorily be supported by all standard DHCP servers (i.e. using only mandatory parameters).

The DNS server may resolve a vendor-specific domain name and—optionally—also an operator-specific domain name, and may return a (PnP-related) network address (e.g. IP@) of a corresponding vendor's Mediator NEM and—optionally—also a network address (e.g. IP@) of the operator's CA server to the NE.

The CA server may provide authentication information (e.g. PKI information) to be used by the NE for connecting to the Mediator NEM e.g. over TLS (employing both authentication and encryption) or IPSec.

The Mediator NEM (one such dedicated node being provided for each vendor's equipment in an operator's network) may store initial configuration data of all NEs (e.g. BTSs) of the respective vendor (but no final configuration data, i.e. detailed planning data). The initial configuration data may only contain connectivity information applicable for the OAM/operational access domain, including a network address (e.g. IP@) of the NEM node containing the final configuration data, i.e. detailed planning data, for the NE and—optionally—also a final network address (e.g. IP@) of the NE itself.

The NEM nodes (only one of which is exemplarily illustrated in FIG. 3) may contain final configuration data, i.e. detailed planning data, of all NEs (e.g. BTSs) of the respective vendor. The operator may provision respective planning data in the NEM nodes, which may upload the initial configuration part thereof to the Mediator NEM of the respective vendor.

The NE may be auto-configured based on the aforementioned operability/functionality of the other entities. Specifically, the NE may connect to the operator network, i.e. the PNP access VLAN, using its initial/temporary identification, and may re-connect to the operator network, i.e. the operational access VLAN, using its final identification, e.g. with the final m-plane IP@.

According to exemplary embodiments of the present invention, initial configuration data stored by the NEM Mediator for all NEs of the corresponding vendor may specifically contain one or more of the following entries: BTS management IP address, BTS transport IP address, BTS VLAN ID, default GW IP address, NEM IP address. Optionally, it may also contain IPSec GW IP address (the IPSec GW may be used to separate the trusted OAM domain from other network parts).

According to exemplary embodiments of the present invention, final configuration data, i.e. detailed network planning of each site, is provisioned from the operator's planning tool to the NEM node dedicated to configure the respective NE (e.g. BTS) that is installed at the site in question. After the provisioning of the network plan, the NEM node uploads the initial configuration part to the NEM Mediator via a unidirectional interface, and maintains the (remaining part of the) final configuration data, i.e. detailed network planning of each site.

According to exemplary embodiments of the present invention, as illustrated in FIG. 3, a vendor-specific FQDN (fully qualified domain name) exemplarily represents a vendor-specific domain name and a CA server FQDN (fully qualified domain name) exemplarily represents an operator-specific domain name. The vendor-specific domain name is for identifying a vendor-specific network element manager mediator entity, i.e. the vendor's NEM Mediator, and the operator-specific domain name is for identifying an operator-specific certification authority entity, i.e. the operator's CA server.

Specifically, the vendor- and operator-specific domain names according to exemplary embodiments of the present invention may be structured to include a vendor/operator-specific part and a fixed part, respectively. In such structure, the vendor-specific domain name may comprise a vendor-specific part for identifying the vendor-specific network element manager mediator entity, i.e. the vendor's NEM Mediator, and a fixed part for identifying an operator network, and/or an operator-specific domain name may comprise an operator-specific part for identifying an operator-specific certification authority entity (providing authentication information for connecting to the NEM Mediator), i.e. the operator's CA server, and a fixed part for identifying an operator network.

For example, the structure of the vendor-specific FQDN used for the NEM Mediator of the corresponding vendor may be as follows:

vendor<VENDOR>.mediator.oam.mnc<MNC>.mcc<MCC>.3gppnetwork.org

For example, the structure of the operator-specific FQDN used for the CA server may be as follows:

ca-server.mediator.oam.mnc<MNC>.mcc<MCC>.3gppnetwork.org

In the above structures, the parts “vendor<VENDOR>.mediator.oam” and “ca-server.mediator.oam” represent the aforementioned vendor- and operator-specific parts, wherein VENDOR represents a unique vendor identifier, respectively. Further, the part “mnc<MNC>.mcc<MCC>.3gppnetwork.org” represents the aforementioned fixed part, wherein MNC and MCC represents the operator's mobile network/country code, and wherein the domain specification “3gppnetwork.org” (including several subdomains for different nodes in an LTE/EPC network) indicates compliance with 3GPP standard for numbering, addressing and identification (according to 3GPP TS 23.003).

According to exemplary embodiments of the present invention, the parts “vendor<VENDOR>.mediator” and “ca-server.mediator” are specifically effective for realizing (secure) multi-vendor support (i.e. multi-vendor level discrimination functionality).

According to exemplary embodiments of the present invention, the vendor- and operator-specific domain names (FQDNs) may be constructed at the network element or at the DNS server. To this end, especially the MNC and MCC of the fixed operator network part may be correspondingly provided for constructing the FQDN as outlined below, thus avoid the need for any pre-configuration of the network element prior to deployment as much as possible.

On the one hand, the fixed part of each FQDN (i.e. “mnc<MCN>.mcc<MCC>.3gppnetwork.org”) may be provisioned in the DNS server as a default realm, and the NE may only send the “ca-server.mediator.oam” and/or “vendor<VENDOR>.mediator.oam” part to the DNS server, which will be completed by the DNS server with the default realm suffix. Such approach is particularly useful in a single operator infrastructure (i.e., when resources (access/transport network, DNS server) are not shared between different operators) or in a shared infrastructure environment, wherein, when one operator takes the lead and provides the infrastructure including the DNS server, it is that operator's MNC and MCC that is provisioned in the DNS server as part of the default realm.

Accordingly, in such approach, the network element may transmit the vendor-specific part of the vendor-specific domain name and/or the operator-specific part of the operator-specific domain name to the domain name service entity. The domain name service entity may receive the vendor-specific part of the vendor-specific domain name and/or the operator-specific part of the operator-specific domain name from the network element, store the fixed part of the vendor-specific domain name and/or the operator-specific domain name, and construct (complete) the vendor-specific domain name and/or the operator-specific domain name based thereon.

On the other hand, the fixed part of each FQDN (i.e. “mnc<MCN>.mcc<MCC>.3gppnetwork.org”) may be sent by the DHCP server to the NE (along with the BTS PnP IP@ and/or the DNS server IP@). Such approach may be useful as a standardized and mandatory function of DHCP, therefore all DHCP server implementations having to provide implementation for such functionality. The disadvantage of this approach when compared to the aforementioned approach may be the additional management requirement for the DHCP server, as the default realm part of the domain name needs to be configured in the DHCP server.

Accordingly, in such approach, the network element may acquire the fixed part of the vendor-specific domain name and/or the operator-specific domain name from a dynamic host configuration protocol entity, construct the vendor-specific domain name and/or the operator-specific domain name based thereon, and transmit the constructed vendor-specific domain name and/or operator-specific domain name to the domain name service entity. The domain name service entity may receive the thus constructed (complete) vendor-specific domain name and/or operator-specific domain name from the network element.

According to exemplary embodiments of the present invention, as illustrated in FIG. 3, the NE may not only request resolution of a vendor-specific domain name (e.g. FQDN) at the DNS and acquire a network address of the NEM Mediator from the DNS, which may then be used for requesting and obtaining initial configuration data from the NEM Mediator. Also, in order to realize security-related aspects, the NE may request resolution of an operator-specific domain name (e.g. FQDN) at the DNS and acquire a network address of the operator-specific CA server from the DNS, which may then be used for requesting and retrieving authentication information from the CA server and setting up a secure connection to the NEM Mediator using the retrieved authentication information.

When both vendor- and operator-specific domain names (e.g. FQDNs) are acquired from the DNS, this may be accomplished in any sequence or (quasi) simultaneously.

According to exemplary embodiments of the present invention, the DNS server is used to resolve the vendor-specific FQDN upon a request from the NE. The network (e.g. IP) address returned as a reply is that of the Mediator NEM of the respective vendor. The Mediator NEM accepts the initial connectivity of all new NEs using authentication and TLS/IPSec as negotiated with the operator's CA server and provides them with the initial configuration data that may contain (among other things) the final IP address for the NE to be used in the OAM access domain and the IP address of the NEM node that contains the detailed planning data for the respective NE.

According to exemplary embodiments of the present invention, the DNS server is used to resolve the operator-specific FQDN upon a request from the NE. The network (e.g. IP) address returned as a reply is that of the operator's CA server. As accessing the CA server may also require a port number and a URL (as indicated in the above table) besides the IP address, there can be different approaches to provide this information to the NE.

On the one hand, standardized parameters of a certificate management protocol (CMP) may be used. In using standardized values, there is already a well-known port for CMP, i.e. port 829 (which may be mandated to be used for CMP). Further, the URL to be sued may be mandated, such as the string “pkix” that is already used by most CA servers. Still further, the CA Subject Name may be either fixed/mandated or its usage may be prohibited by standards.

On the other hand, domain name service (DNS) text (TXT) resource records (RR) may be used. In using DNS TXT resource records, there may be a TXT RR associated with a specific type of DNS resource record. For example, such TXT RR may be associated with the A or AAAA RR containing the CA server IP (IPv4 or IPv6) address, specifying all required additional information, i.e. the CMP port, Path and Subject Name. In this case, the structure of the TXT RR may be standardized, e.g. “port=<PORT>, path=<PATH>, subject=<SUBJECT>”.

According to exemplary embodiments of the present invention, the DNS server (i.e. the respective multi-vendor support mapping) may be updated (manually) via an operator console or (dynamically) by a dynamic domain name service. In this regard, mapping updates may be accomplished by updating/modifying of the locally stored mapping via an operator console and/or via the vendor-specific network element manager mediator entities and/or the operator-specific certification authority entity, and/or mapping updates may be accomplished by receipt of an updated/modified mapping from an operator console and/or from the vendor-specific network element manager mediator entities and/or the operator-specific certification authority entity. Thereby, the network address of the NEM Mediator (and optionally the network address of the operator's CA server) may be kept up-to-date in the DNS server.

A (manual) updating via an operator console may be most efficient, as there is a low number of DNS records (i.e. one per vendor plus that of the CA server), resulting in not much effort for manual updating. Also, such (manual) updating may be preferable in terms of security issues, as it requires no interface between the NEM Mediators/CA server and the DNS server.

A (dynamic) updating by dynamic DNS means that the NEM Mediators and the CA server update their own network address to the DNS server when it changes. Such approach alleviates all additional management burdens of the provisioning of the DNS server, also giving the operator the choice of policy for managing the network addresses of the NEM Mediators and/or the CA server. These can be static, which means that the network address is updated only once in the DNS server, but it can also be dynamic via DHCP or any other address management facility, in which case a network address would automatically be updated to the DNS server whenever it changes in a NEM Mediator and/or CA server. Despite the convenience of automatic updating, the security-related requirement for an interface between the NEM Mediators and/or the CA server may render this approach less preferred.

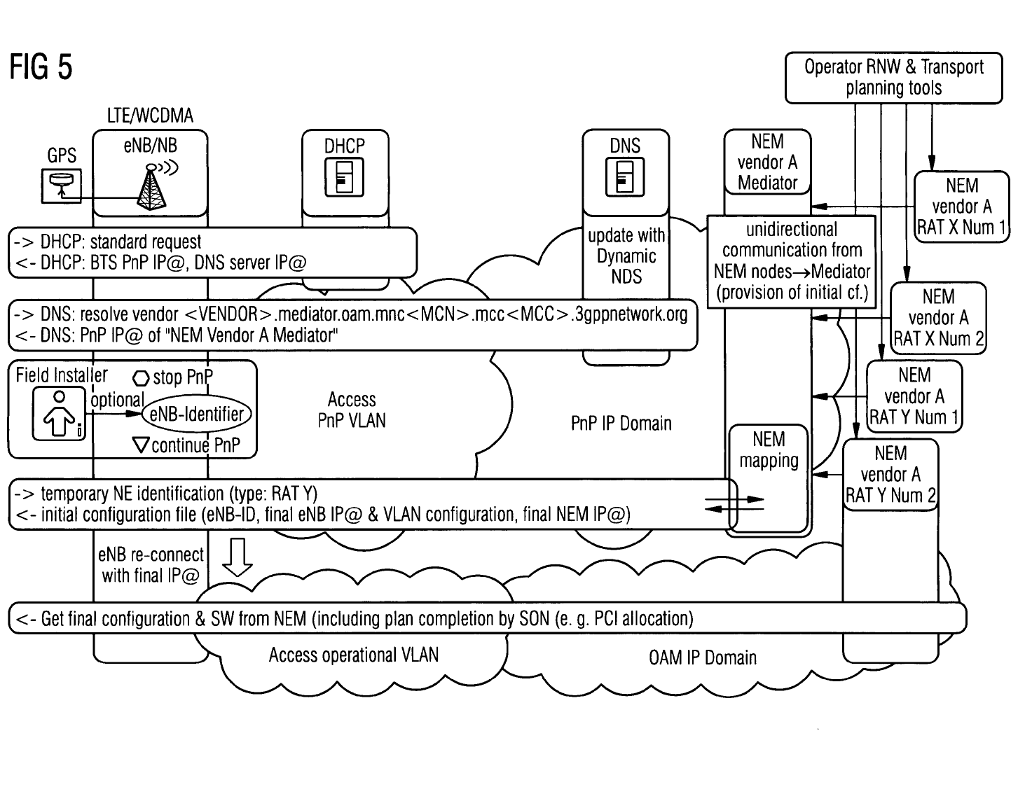

FIG. 5 shows a schematic diagram of a second example of a network element auto-configuration framework according to exemplary embodiments of the present invention, wherein a single-vendor case is exemplarily illustrated, and wherein security-related aspects are omitted for the sake of clarity.

The exemplary system infrastructure according to FIG. 5 is similar to that according to FIG. 4, and thus reference is made to the above description for details. Accordingly, the exemplary system infrastructure according to FIG. 5 constitutes a unified (i.e. multi-vendor, multi-RAT, and multi-NEM capable) network element auto-configuration framework providing for multi-vendor support (i.e. multi-vendor level discrimination functionality) by virtue of the DNS server (and the associated domain name (FQDN) concept) and multi-NEM/RAT support (i.e. multi-NEM/multi-RAT level discrimination functionality) by virtue of the NEM Mediator.

In this regard, it is evident from FIG. 5 that the thus illustrated network element auto-configuration framework supports multiple NEM nodes within the same RAT (i.e. multi-NEM capability) and different NEM nodes for different RATs (i.e. multi-RAT capability).

Similar to FIG. 4, the underlying communication system according to FIG. 5 is structured into separated PnP and operational access VLANs and separated PnP and OAM IP domains, thereby realizing a true domain separation.

The auto-connection and auto-commissioning framework according to FIG. 5, i.e. the vendor-specific plug-and-play functionality according to exemplary embodiments of the present invention, may be summarized as follows.

In terms of basic characteristics, as evident from the above, it may be noted that
separated PnP and OAM IP domain/networks exist with dedicated VLAN for PnP identifiable by VLAN probing (optional),
the Mediator NEM belongs to PnP IP domain, the final/actual NEM belongs to OAM IP domain,
the DHCP server is only used for getting IP@ of DNS server,
the DNS Server is used to get IP@ of vendor-specific Mediator NEM, from which the initial configuration file is downloaded, and
the final self-configuration from OAM domain is accomplished only through final VLAN access network with pre-planned m-plane IP@.

In view thereof, the following preparations are assumed:
the IP@ of the DNS server is set in the DHCP server,
for each vendor's Mediator NEM, a specific FQDN is provisioned and kept up-to-date in the DNS server either manually or by the respective Mediator NEM via dynamic DNS,
the operator's CA server IP@ is provisioned in the DNS server, and
each NEM node uploads the initial configuration of the planning data to the respective vendor's Mediator NEM via an unidirectional interface.

In the actual PnP auto-configuration sequence, the eNB may firstly (optionally) run a VLAN probing sequence for identifying the dedicated PnP access VLAN to be used for PnP auto-configuration. Then, the eNB may run a DHCP sequence in cooperation with the DHCP server, thereby getting a temporary NE identification (denoted as BTS PnP IP@) to be used for PnP auto-configuration and a DNS server IP@.

Based thereon, the eNB may connect to the operator network, i.e. the PNP access VLAN, using its temporary identification. Thereupon, the eNB may query the DNS server for operator-specific FQDN to obtain CA server IP@, the eNB may query the DNS server for vendor-specific FQDN to obtain Mediator NEM IP@, and the eNB may connect to the CA server to obtain PKI information as authentication information to be used for connecting to the NEM Mediator.

In case no GPS or another positioning service is available at the eNB for enabling a hardware-to-site mapping, the PnP auto-configuration sequence may stop after auto-connection (and security credential provisioning from RA/CA), a field installer may inject an eNB identifier which is unambiguously linked to a site location, and the PnP auto-configuration sequence may continue accordingly. In case GPS or another positioning service is available at the eNB, a fully automated hardware-to-site mapping may be performed using the geo-location information at this step, i.e. the PnP auto-configuration sequence does not have to be interrupted.

Further, the eNB may perform a TLS setup between the eNB and the NEM Mediator. On such secure TLS connection, the eNB may send its temporary NE identifier (e.g. geo-location, or site-ID, etc.) to the NEM Mediator, and the NEM Mediator may validate the final NE identifier corresponding to its temporary identifier, and may send initial configuration data to the eNB (initial=pre-configured configuration file without SON completion).

Based thereon, the eNB may re-connect to the operator network, i.e. the operational access VLAN, using its final identification, i.e. with the final m-plane IP@. Thereby, the eNB may connect to the final/actual NEM node and download final configuration data and software from the responsible/relevant NEM node. Thereupon, the network integration may continue accordingly.

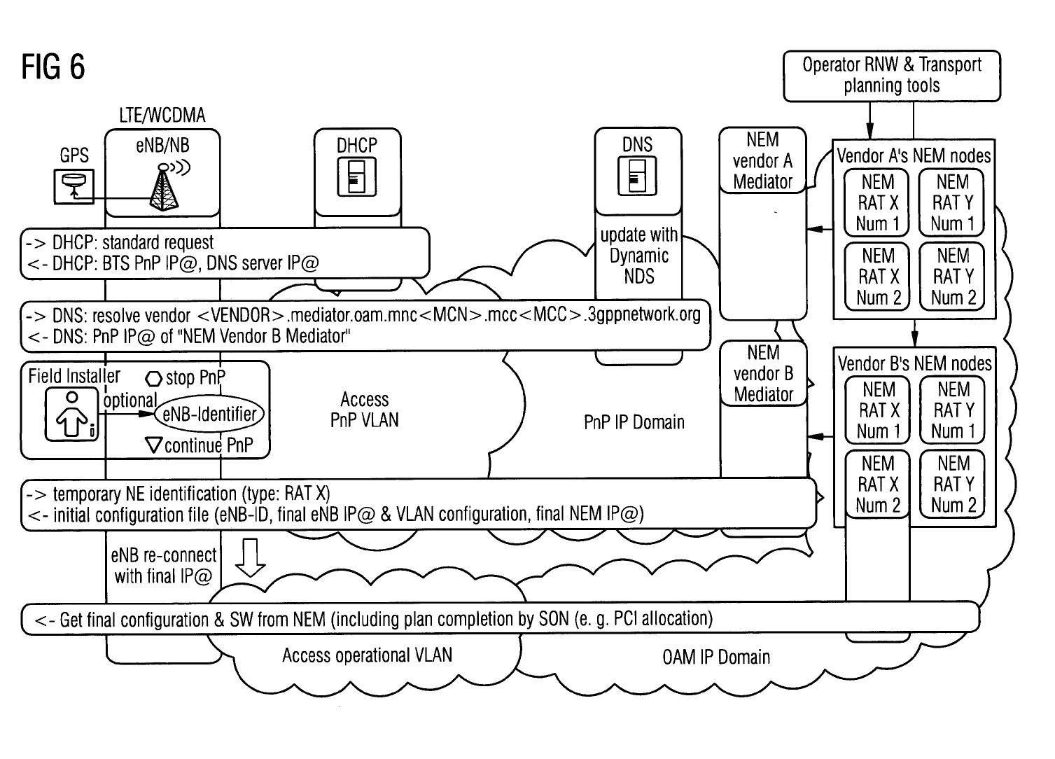

FIG. 6 shows a schematic diagram of a third example of a network element auto-configuration framework according to exemplary embodiments of the present invention, wherein a multi-vendor case is exemplarily illustrated, and wherein security-related aspects are omitted for the sake of clarity.

The exemplary system infrastructure according to FIG. 6 is similar to that according to FIGS. 4 and 5, and thus reference is made to the above description for details. Accordingly, the exemplary system infrastructure according to FIG. 6 constitutes a unified (i.e. multi-vendor, multi-RAT, and multi-NEM capable) network element auto-configuration framework providing for multi-vendor support (i.e. multi-vendor level discrimination functionality) by virtue of the DNS server (and the associated domain name (FQDN) concept) and multi-NEM/RAT support (i.e. multi-NEM/multi-RAT level discrimination functionality) by virtue of the NEM Mediator.

The exemplary system infrastructure according to FIG. 6 differs from that according to FIG. 5 merely in that an exemplary multi-vendor case is illustrated. Namely, focus is made on the multi-vendor capability, exemplarily depicting nodes from two presumed vendors, i.e. “vendor A” and “vendor B”.

The auto-connection and auto-commissioning framework according to FIG. 6, i.e. the multi-vendor plug-and-play functionality according to exemplary embodiments of the present invention, is basically equivalent to that described above in connection with FIG. 5. As evident from FIG. 6, it is presumed in the thus illustrated exemplary use case that the eNB/NB is sold by vendor B and is operational in/with exemplary RAT X. Further, it is presumed that, as two NEM nodes are available for RAT X NEs of vendor B, NEM RAT X node number 2 is exemplarily responsible/relevant for the eNB/NB to be auto-configured.

Referring to the foregoing explanations regarding the present invention and its aspects and embodiments, the following features and effects of exemplary embodiments of the present invention may be outlined.

A first aspect of exemplary embodiments of the present invention basically resides in the usage of domain name service to provide a first level of indirection, i.e. multi-vendor support.

Thereby, deployment efficiency may be achieved in terms of a re-use of existing network servers. Usage of DNS facilitates deployment because only a single DNS server in a network domain needs to be maintained and there are no known problems in interoperability between DNS protocol entities (like those described problems for DHCP). Furthermore, often DNS is in use anyway in a network domain to avoid dealing with lists of numeric IP addresses. Some IP router vendors also offer built-in DHCP and/or DNS server services in their products. If the network operator uses such routers, there is no need for physically deploying new nodes/servers for providing the necessary DHCP and/or DNS functionalities, thereby mitigating the deployment and (to some extent) the maintenance cost of these nodes/servers.

A second aspect of exemplary embodiments of the present invention basically resides in the introduction of a NEM Mediator function/node to provide a second level of indirection, i.e. multi-RAT/multi-NEM support.

The NEM Mediator function/node represents a frontend to vendor's other NEM nodes, thereby supporting different NEMs for different RATs (i.e. multi-RAT capability) and supporting multiple NEMs of the same type/RAT (i.e. multi-NEM capability), e.g., multiple vendor-specific NEM entities such as multiple 3G NSN NetAct nodes. Thereby, NEM/RAT mapping may be accomplished on the basis of base station type/capability/RAT (which may be vendor-specific). The NEM Mediator provides the second level of indirection which facilitates the separation into PnP and OAM access domain (as the NEM Mediator is located in the PnP access domain, while other NEMs are located in the OAM access domain).

A further aspect of exemplary embodiments of the present invention basically resides in the provision of a unidirectional interface between the NEM Mediator and other NEMs of/for the same vendor.

The interface between the NEM nodes of a vendor and the NEM Mediator function/node of the same vendor is unidirectional, i.e. connection establishment is only possible from one of the NEM nodes towards the NEM Mediator but not vice versa. This can for example be implemented by a firewall. Such design is effective for enabling improved security. This is because, if the NEM Mediator function/node is attacked (from the PnP access domain), still there is no further possibility to compromise any of the NEM nodes, preserving the functionality of the OAM system for already established network elements and ensuring continuity of service. Additionally, the NEM Mediator function/node may be evolved so as to provide for a secure interface requiring CA-based authentication of NEM nodes.

As outlined above, the unified network element auto-configuration framework (including architecture, i.e. nodes/functions, and sequence, i.e. procedures/operations) according to exemplary embodiments of the present invention provides for multi-vendor, multi-RAT, and multi-NEM capabilities.

By virtue of the multi-vendor capability according to exemplary embodiments of the present invention, NEs of different vendors are able to connect to the OAM system in a unified (standardized) way for different vendors without pre-configuring any vendor-specific data in the NEs prior to field installation.

By virtue of the multi-RAT capability according to exemplary embodiments of the present invention, NEs (e.g. base stations) from the same vendor implementing different/multiple radio access technologies (RATs) (e.g. WCDMA, LTE, etc.) are able to automatically connect to the appropriate NEM node and receive their configuration, especially when there are different NEM nodes for different RATs.

By virtue of the multi-NEM capability according to exemplary embodiments of the present invention, multiple NEM nodes within the same vendor and same RAT (e.g. multiple vendor-specific NEM entities such as multiple 3G NSN NetAct nodes) are supported, while there is a direct mapping between NEM nodes and NEs so that, if a NE initially connects to the network, it may (automatically) connect to the particular NEM node that hosts its configuration (planning data). Accordingly, each NE is enabled to map to a specific instance of a NEM from an available set of suitable NEM nodes.

Additionally, the unified network element auto-configuration framework (including architecture, i.e. nodes/functions, and sequence, i.e. procedures/operations) according to exemplary embodiments of the present invention satisfies various requirements/characteristics (established by operators) for advanced plug-and-play solutions which may enable widespread adoption in modern communication systems. Such subsequently outlined requirements/characteristics span across the aforementioned “multi-x” capabilities, i.e. every single vendor solution and the multi-vendor integration part are to satisfy these requirements/characteristics (like, e.g., security).

The unified network element auto-configuration framework according to exemplary embodiments of the present invention is capable of providing for true plug-and-play (PnP), i.e. a true PnP connectivity setup.

Thereby, NEs do not require provisioning of any initial configuration in the factory prior to the field installation. This facilitates off-the-shelf NE deployment by decoupling the configuration data from the actual hardware instances. By virtue of a hardware-to-site-mapping process, the site may be identified, at which a given NE instance is installed, and, based on the site identity, the corresponding configuration data may be retrieved from the planning database prepared for that site. Further, the required pre-configuration of the access network, to which the NEs will be connected, may be minimized.

The unified network element auto-configuration framework according to exemplary embodiments of the present invention is capable of providing for true domain separation, i.e. full separation of the “PnP” and “OAM access” network domains.

Thereby, the operator's VLAN and IP access networks may be completely split into two parts. The PnP access domain, used by NEs for the initial access, may be shared by all vendors that have NEs in the operator's network. The OAM domain, however, requires PKI-based authentication of the NEs, and there can be a separate OAM domain for each vendor.

The unified network element auto-configuration framework according to exemplary embodiments of the present invention is capable of providing for security.

Specifically, multi-homing in both access domains (i.e. a node with interfaces in both PnP and OAM domain) may be avoided. This is effective in terms of security, as nodes directly accessible from the PnP domain are seen to be less secure (i.e. more exposed to attackers), which is why their separation from nodes within the OAM (trusted) domain is preferable. Nevertheless, a secure protocol (such as e.g. TLS/IPsec) may still be applicable when the NE is accessing a node within the PnP domain.

Incidentally, the unified network element auto-configuration framework according to exemplary embodiments of the present invention is capable of keeping implementation cost down on both vendor and operator side.

The above-described procedures and functions may be implemented by respective functional elements, processors, or the like, as described below.

While in the foregoing exemplary embodiments of the present invention are described mainly with reference to methods, procedures and functions, corresponding exemplary embodiments of the present invention also cover respective apparatuses, network nodes and systems, including both software and/or hardware thereof.

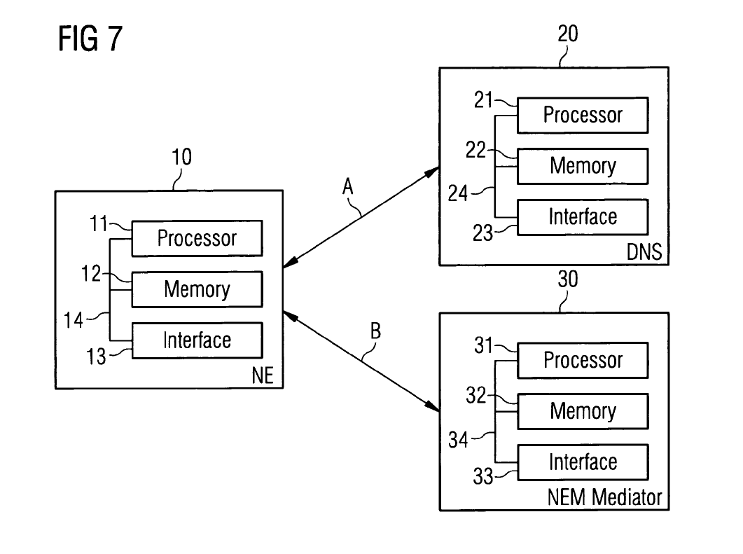

Respective exemplary embodiments of the present invention are described below referring to FIG. 7, while for the sake of brevity reference is made to the detailed description of respective corresponding schemes, methods and functionality, principles and operations according to FIGS. 3 to 6.

In FIG. 7 below, the solid line blocks are basically configured to perform respective operations as described above. The entirety of solid line blocks are basically configured to perform the methods and operations as described above, respectively. With respect to FIG. 7, it is to be noted that the individual blocks are meant to illustrate respective functional blocks implementing a respective function, process or procedure, respectively. Such functional blocks are implementation-independent, i.e. may be implemented by means of any kind of hardware or software, respectively. The arrows and lines interconnecting individual blocks are meant to illustrate an operational coupling there-between, which may be a physical and/or logical coupling, which on the one hand is implementation-independent (e.g. wired or wireless) and on the other hand may also comprise an arbitrary number of intermediary functional entities not shown. The direction of arrow is meant to illustrate the direction in which certain operations are performed and/or the direction in which certain data is transferred.

Further, in FIG. 7, only those functional blocks are illustrated, which relate to any one of the above-described methods, procedures and functions. A skilled person will acknowledge the presence of any other conventional functional blocks required for an operation of respective structural arrangements, such as e.g. a power supply, a central processing unit, respective memories or the like. Among others, memories are provided for storing programs or program instructions for controlling the individual functional entities to operate as described herein.

FIG. 7 shows a schematic diagram of exemplary apparatuses of a network element auto-configuration framework according to exemplary embodiments of the present invention.

In view of the above, the thus described apparatuses 10, 20 and 30 are suitable for use in practicing the exemplary embodiments of the present invention, as described herein.

The thus described apparatus 10 may represent a (part of a) network element such as a base station, BTS, eNB, NB or the like, and may be configured to perform a procedure and/or exhibit a functionality as evident from any one of FIGS. 3 to 6. The thus described apparatus 20 may represent a (part of a) domain name service entity such as a DNS server/function or the like, and may be configured to perform a procedure and/or exhibit a functionality as evident from any one of FIGS. 3 to 6. The thus described apparatus 30 may represent a (part of a) vendor-specific network element manager mediator entity such as a NEM Mediator function/node or the like, and may be configured to perform a procedure and/or exhibit a functionality as evident from any one of FIGS. 3 to 6.

As indicated in FIG. 7, according to exemplary embodiments of the present invention, each of the apparatuses comprises a processor 11/21/31, a memory 12/22/32 and an interface 13/23/33, which are connected by a bus 14/24/34 or the like, and the apparatuses may be connected via links A and B, respectively.

Although not illustrated in FIG. 7, apparatuses according to exemplary embodiments of the present invention may also involve a DHCP server/function or the like, a CA server/function or the like, and one or more NEM nodes/functions or the like, which may be configured to perform a procedure and/or exhibit a functionality as evident from any one of FIGS. 3 to 6, respectively. Accordingly, the apparatus 10 may be additionally connected via a link (not illustrated) to the DHCP server/function and/or the CA server/function, and/or the apparatus 30 may be additionally connected via one or more links (not illustrated) to the one or more NEM nodes/functions.

The processor 11/21/31 and/or the interface 13/23/33 may also include a modem or the like to facilitate communication over a (hardwire or wireless) link, respectively. The interface 13/23/33 may include a suitable transceiver coupled to one or more antennas or communication means for (hardwire or wireless) communications with the linked or connected device(s), respectively. The interface 13/23/33 is generally configured to communicate with at least one other apparatus, i.e. the interface thereof.

The memory 12/22/32 may store respective programs assumed to include program instructions or computer program code that, when executed by the respective processor, enables the respective electronic device or apparatus to operate in accordance with the exemplary embodiments of the present invention. For example, the apparatuses 10 and 20 may store (parts of) vendor-/operator-specific domain names, and/or the apparatuses 20 and 30 may store respective mappings as outlined above, and/or the apparatus 30 may store initial configuration data for various network elements, and/or the like.

In general terms, the respective devices/apparatuses (and/or parts thereof) may represent means for performing respective operations and/or exhibiting respective functionalities, and/or the respective devices (and/or parts thereof) may have functions for performing respective operations and/or exhibiting respective functionalities.

When in the subsequent description it is stated that the processor (or some other means) is configured to perform some function, this is to be construed to be equivalent to a description stating that a (i.e. at least one) processor or corresponding circuitry, potentially in cooperation with computer program code stored in the memory of the respective apparatus, is configured to cause the apparatus to perform at least the thus mentioned function. Also, such function is to be construed to be equivalently implementable by specifically configured circuitry or means for performing the respective function (i.e. the expression “processor configured to [cause the apparatus to] perform xxx-ing” is construed to be equivalent to an expression such as “means for xxx-ing”).

In its most basic form, according to exemplary embodiments of the present invention, the apparatus 10 or its processor 11 is configured to perform requesting resolution of a vendor-specific domain name at a domain name service entity, acquiring a network address of a vendor-specific network element manager mediator entity from the domain name service entity, requesting initial configuration data using the acquired network address of the vendor-specific network element manager mediator entity, and obtaining the initial configuration data, comprising a network address of a network element manager entity providing final configuration data, from the vendor-specific network element manager mediator entity.

In its most basic form, according to exemplary embodiments of the present invention, the apparatus 20 or its processor 21 is configured to perform, upon request from a network element of a specific vendor, which is operable in a radio access network of a specific operator using a specific radio access technology, resolving a vendor-specific domain name using a mapping between vendor-specific domain names and vendor-specific network element manager mediator entities of multiple vendors, and providing a network address of a vendor-specific network element manager mediator entity of the vendor of the network element to the network element.

In its most basic form, according to exemplary embodiments of the present invention, the apparatus 30 or its processor 31 is configured to perform, upon request from a network element of a specific vendor, which is operable in a radio access network of a specific operator using a specific radio access technology, identifying initial configuration data for the network element using a mapping between network elements and initial configuration data of multiple network element manager entities of the specific vendor, and providing the identified initial configuration data, comprising a network address of the network element manager entity providing final configuration data for the network element, to the network element.

For further details regarding the operability/functionality of the individual apparatuses, reference is made to the abode description in connection with any one of FIGS. 3 to 6, respectively.

According to exemplarily embodiments of the present invention, the processor 11/21, the memory 12/22 and the interface 13/23 may be implemented as individual modules, chips, chipsets, circuitries or the like, or one or more of them can be implemented as a common module, chip, chipset, circuitry or the like, respectively.

According to exemplarily embodiments of the present invention, a system may comprise any conceivable combination of the thus depicted devices/apparatuses and other network elements, which are configured to cooperate as described above.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present invention. Such software may be software code independent and can be specified using any known or future developed programming language, such as e.g. Java, C++, C, and Assembler, as long as the functionality defined by the method steps is preserved. Such hardware may be hardware type independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components. A device/apparatus may be represented by a semiconductor chip, a chipset, or a (hardware) module comprising such chip or chipset; this, however, does not exclude the possibility that a functionality of a device/apparatus or module, instead of being hardware implemented, be implemented as software in a (software) module such as a computer program or a computer program product comprising executable software code portions for execution/being run on a processor. A device may be regarded as a device/apparatus or as an assembly of more than one device/apparatus, whether functionally in cooperation with each other or functionally independently of each other but in a same device housing, for example.

Apparatuses and/or means or parts thereof can be implemented as individual devices, but this does not exclude that they may be implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present invention also covers any conceivable combination of method steps and operations described above, and any conceivable combination of nodes, apparatuses, modules or elements described above, as long as the above-described concepts of methodology and structural arrangement are applicable.

In view of the above, there are provided measures for a unified (i.e. multi-vendor, multi-RAT, and multi-NEM capable) network element auto-configuration framework. Such measures exemplarily comprise multi-vendor level discrimination functionality at a domain name service entity and multi-NEM/multi-RAT level discrimination functionality at a vendor-specific network element manager mediator entity having a unidirectional interface with vendor-specific network element manager entities, wherein a network element may be automatically configured with initial configuration data comprising a network address of a network element manager entity providing final configuration data for the network element.

The measures according to exemplary embodiments of the present invention may be applied for any kind of network environment, such as for example for communication systems in accordance with 3GPP UMTS and/or 3GPP LTE standards of release 10/11/12/ . . . (including LTE-Advanced and its evolutions).

Even though the invention is described above with reference to the examples according to the accompanying drawings, it is to be understood that the invention is not restricted thereto. Rather, it is apparent to those skilled in the art that the present invention can be modified in many ways without departing from the scope of the inventive idea as disclosed herein.

### LIST OF ACRONYMS AND ABBREVIATIONS

3GPP Third Generation Partnership Project
BTS Base Transceiver Station
CA Certification Authority
CMP Certificate Management Protocol
DHCP Dynamic Host Configuration Protocol
DNS Domain Name Service
eNB evolved NodeB (base station)
EPC Evolved Packet Core
FQDN Fully Qualified Domain Name
HTTP Hypertext Transfer Protocol
GPS Global Positioning System
GW Gateway
iOMS Integrated Operation Mediation Subsystem
IP Internet Protocol
IP@ IP address
LTE Long Term Evolution
MCC Mobile Country Code
MNC Mobile Network Code
NB NodeB (base station)
NE Network Element
NEM Network Element Manager
OAM Operation, Administration and Maintenance
OSI Open Systems Interconnection Reference Model
PKI Public Key Infrastructure
PnP Plug and Play
RA Registration Authority
RAT Radio Access Technology
RNW Radio Network
RR Resource Record
SON Self Organizing Network
SW Software
TLS Transport Layer Security
TXT Text
UMTS Universal Mobile Telecommunications System
URL Uniform Resource Locator
VLAN Virtual Local Area Network
WCDMA Wideband Code Division Multiple Access

1. A method comprising
requesting resolution of a vendor-specific domain name at a domain name service entity,
acquiring a network address of a vendor-specific network element manager mediator entity from the domain name service entity,
requesting initial configuration data using the acquired network address of the vendor-specific network element manager mediator entity, and
obtaining the initial configuration data, comprising a network address of a network element manager entity providing final configuration data, from the vendor-specific network element manager mediator entity.

2.-6. (canceled)

7. A method comprising
upon request from a network element of a specific vendor, which is operable in a radio access network of a specific operator using a specific radio access technology, resolving a vendor-specific domain name using a mapping between vendor-specific domain names and vendor-specific network element manager mediator entities of multiple vendors, and
providing a network address of a vendor-specific network element manager mediator entity of the vendor of the network element to the network element.

8.-12. (canceled)

13. A method comprising
upon request from a network element of a specific vendor, which is operable in a radio access network of a specific operator using a specific radio access technology, identifying initial configuration data for the network element using a mapping between network elements and initial configuration data of multiple network element manager entities of the specific vendor, and
providing the identified initial configuration data, comprising a network address of the network element manager entity providing final configuration data for the network element, to the network element.

14.-18. (canceled)

19. An apparatus comprising
an interface configured to communicate with at least another apparatus, and
a processor configured to cause the apparatus to perform:
requesting resolution of a vendor-specific domain name at a domain name service entity,
acquiring a network address of a vendor-specific network element manager mediator entity from the domain name service entity,
requesting initial configuration data using the acquired network address of the vendor-specific network element manager mediator entity, and
obtaining the initial configuration data, comprising a network address of a network element manager entity providing final configuration data, from the vendor-specific network element manager mediator entity.

20. The apparatus according to claim 19, wherein the processor is further configured to cause the apparatus to perform:
requesting resolution of an operator-specific domain name at the domain name service entity,
acquiring a network address of an operator-specific certification authority entity from the domain name service entity,
requesting authentication information using the acquired network address of the operator-specific certification authority entity,
retrieving the authentication information from the operator-specific certification authority entity, and
setting up a secure connection to the vendor-specific network element manager mediator entity using the retrieved authentication information.

21. The apparatus according to claim 19, wherein
the vendor-specific domain name comprises a vendor-specific part for identifying the vendor-specific network element manager mediator entity and a fixed part for identifying an operator network, and/or an operator-specific domain name comprises an operator-specific part for identifying an operator-specific certification authority entity providing authentication information for connecting to the vendor-specific network element manager mediator entity and the fixed part for identifying the operator network, and
wherein the processor is further configured to cause the apparatus to perform:
transmitting the vendor-specific part of the vendor-specific domain name and/or the operator-specific part of the operator-specific domain name to the domain name service entity, or
acquiring the fixed part of the vendor-specific domain name and/or the operator-specific domain name from a dynamic host configuration protocol entity, constructing the vendor-specific domain name and/or the operator-specific domain name based thereon, and transmitting the constructed vendor-specific domain name and/or operator-specific domain name to the domain name service entity.

22. The apparatus according to claim 19, wherein the processor is further configured to cause the apparatus to perform:
acquiring a network address of the domain name service entity from a dynamic host configuration protocol entity, and utilizing the acquired network address of the domain name service entity in the resolution requesting, and/or
acquiring an initial network address of the apparatus from a dynamic host configuration protocol entity, and utilizing the acquired network address of the apparatus in at least one of the acquiring and the obtaining.

23. The apparatus according to claim 19, wherein
the initial configuration data further comprise a final network address of an apparatus, and the processor is further configured to cause the apparatus to perform obtaining the final configuration data using a connection to the network element manager entity set up using the final network address of the apparatus, and/or
the final configuration data comprise detailed network planning information for the apparatus.

24. The apparatus according to claim 19, wherein
the apparatus is operable as or at a network element of a specific vendor, which is operable in a radio access network of a specific operator using a specific radio access technology, and/or
the domain name service entity and the vendor-specific network element manager mediator entity are located in a plug-and-play domain of a radio access network and/or are accessible via a plug-and-play access virtual network of the radio access network, and the network element manager entity is located in an operation, administration and maintenance domain of the radio access network and/or is accessible via an operational access virtual network of the radio access network.

25. An apparatus comprising
an interface configured to communicate with at least another apparatus, and
a processor configured to cause the apparatus to perform:
upon request from a network element of a specific vendor, which is operable in a radio access network of a specific operator using a specific radio access technology, resolving a vendor-specific domain name using a mapping between vendor-specific domain names and vendor-specific network element manager mediator entities of multiple vendors, and
providing a network address of a vendor-specific network element manager mediator entity of the vendor of the network element to the network element.

26. The apparatus according to claim 25, wherein the processor is further configured to cause the apparatus to perform:
upon request from the network element, resolving an operator-specific domain name using a mapping between operator-specific domain name and operator-specific certification authority entity of an operator of an operator network, and
providing a network address of the operator-specific certification authority entity to the network element.

27. (canceled)

28. The apparatus according to claim 25, wherein
the vendor-specific domain name comprises a vendor-specific part for identifying the vendor-specific network element manager mediator entity and a fixed part for identifying an operator network, and/or an operator-specific domain name comprises an operator-specific part for identifying an operator-specific certification authority entity providing authentication information for connecting to the vendor-specific network element manager mediator entity and the fixed part for identifying the operator network, and
wherein the processor is further configured to cause the apparatus to perform:
receiving the vendor-specific part of the vendor-specific domain name and/or the operator-specific part of the operator-specific domain name from the network element, storing the fixed part of the vendor-specific domain name and/or the operator-specific domain name, and constructing the vendor-specific domain name and/or the operator-specific domain name based thereon, or
receiving the vendor-specific domain name and/or operator-specific domain name from the network element.

29. The apparatus according to claim 25, wherein
the mapping is updated via an operator console or by a dynamic domain name service via the vendor-specific network element manager mediator entities and/or the operator-specific certification authority entity, and/or
the vendor-specific network element manager mediator entity provides initial configuration data for the network element, comprising a network address of a network element manager entity providing final configuration data for the network element.

30. The apparatus according to claim 25, wherein
the apparatus is operable as or at a domain name service entity which is operable in a radio access network of a specific operator using a specific radio access technology, and/or
the domain name service entity and the vendor-specific network element manager mediator entity are located in a plug-and-play domain of a radio access network and/or are accessible via a plug-and-play access virtual network of the radio access network.

31. An apparatus comprising
an interface configured to communicate with at least another apparatus, and
a processor configured to cause the apparatus to perform:
upon request from a network element of a specific vendor, which is operable in a radio access network of a specific operator using a specific radio access technology, identifying initial configuration data for the network element using a mapping between network elements and initial configuration data of multiple network element manager entities of the specific vendor, and
providing the identified initial configuration data, comprising a network address of the network element manager entity providing final configuration data for the network element, to the network element.

32. The apparatus according to claim 31, wherein
the identifying is based on the operability of the network element in the specific radio access technology, and one or more of the multiple network element manager entities of the specific vendor relate to different radio access technologies of network elements of the specific vendor, and/or
the identifying is based on a type or capability of the network element, and one or more of the multiple network element manager entities of the specific vendor relate to different types or capabilities of network elements of the specific vendor.

33. The apparatus according to claim 31, wherein
the initial configuration data of the multiple network element manager entities of the specific vendor are uploaded from the respective network element manager entities via a unidirectional interface, and/or
the initial configuration data of the multiple network element manager entities relate to all network elements of the specific vendor.

34. (canceled)

35. The apparatus according to claim 31, wherein
the initiation and the providing are performed using an initial network address of the network element,
the initial configuration data further comprise a final network address of the network element, and/or
the final configuration data comprise detailed network planning information for the network element.

36. The apparatus according to claim 31, wherein
the apparatus is operable as or at a vendor-specific network element manager mediator entity, and/or
the vendor-specific network element manager mediator entity is located in a plug-and-play domain of a radio access network and/or is accessible via a plug-and-play access virtual network of the radio access network, and the multiple network element manager entities are located in an operation, administration and maintenance domain of the radio access network and/or are accessible via an operational access virtual network of the radio access network.

37. A computer program product comprising computer-executable computer program code which, when the program is run on a computer, is configured to cause the computer to carry out the method according to claim 1.

38. The computer program product according to claim 37, wherein the computer program product comprises a computer-readable medium on which the computer-executable computer program code is stored, and/or wherein the program is directly loadable into an internal memory of the processor.
